(19) United States
(12) Patent Application Publication
(10) Pub. No.: US 2014/0250144 A1
(43) Pub. Date: Sep. 4, 2014

(54) METHOD AND SYSTEM FOR ENABLING ELECTRONIC COMMUNICATION THROUGH CONNECTIVITY OF SEPARATE SOCIAL GRAPHS

(71) Applicant: LEON GUZENDA, RIO VISTA, CA (US)

(72) Inventor: LEON GUZENDA, RIO VISTA, CA (US)

(21) Appl. No.: 13/831,235

(22) Filed: Mar. 14, 2013

Related U.S. Application Data
(63) Continuation-in-part of application No. 13/783,233, filed on Mar. 2, 2013.

(51) Int. Cl. G06F 17/30

(52) U.S. Cl. CPC G06F 17/30477
USPC 707/769

(57) ABSTRACT

A server receives a query message from a requester that identifies a source node of a first graph and includes a target information. The server then preferably searches a plurality of graphs to locate one or more nodes that include or are associated with the target information. When one or more target nodes are found by the server, the server informs the requester and requests authorization to attempt to form a pathway between the source node and one or more target nodes. The server may offer additional information harvested from a target node to the requester in order to encourage the requesting party to authorize pathway formation to the instant target node. The server directs an electronic message that may comprise an invitation to link through a graph, a network address of the source node, and/or an identifier of the requesting party.

### CO-PENDING PATENT APPLICATION

This Nonprovisional Patent Application is a Continuation-in-Part Application to Nonprovisional patent application Ser. No. 13/783,233 filed on Mar. 2, 2013 by inventor Leon Guzenda and titled METHOD AND SYSTEM FOR PERFORMING SEARCHES OF GRAPHS AS REPRESENTED WITHIN AN INFORMATION TECHNOLOGY SYSTEM. Nonprovisional patent application Ser. No. 13/783,233 is hereby incorporated by reference in its entirety and for all purposes, to include claiming benefit of the priority date of filing of Nonprovisional patent application Ser. No. 13/783,233.

### FIELD OF THE INVENTION

The present invention generally relates to electronically represented graphs as maintained and generated by information technology, and more particularly to searching across two or more graphs to enable communications between two nodes.

### BACKGROUND OF THE INVENTION

The subject matter presented in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Graphs, including social graphs, are becoming increasingly expansive, common and valuable as assets of applied information technology. The increasing ubiquity and scope of information technology networks that are represented by digitally stored graphs, such as telecommunication networks, computer networks, biological networks, cognitive and semantic networks, and social networks offers many opportunities to derive value through forming query pathways across unconnected or separated graphs.

It is understood that the range of meaning of the term graph as applied in the present disclosure includes social graphs, and that meaning of the term “graph” in the context of the present disclosure may be expressed as an abstraction of entities and relationships modeled by a collection of “vertices” or “nodes” wherein a collection of edges connect pairs of vertices. The exemplary graphs addressed and presented in the present disclosed should not be confused with the graphs of mathematical functions.

A social network is an instantiation of a social graph and refers to a set of social entities that interact and exchange information in a social relationship. Social entities include, for example, people, teams, groups, organizations, and countries, while social relationships refer to friendship, employment, or other relationships between these social entities. Graphs may also describe objects and/or information elements that are related and are modeled as a grouping of edges connect pairs of vertices.

While the prior art offers numerous approaches to harvesting information by performing search queries within graphs, it fails to optimally address finding pathways between nodes of separated or disconnected graphs. There is therefore a long felt need to provide a method and device that enables the forming of connectivity pathways between nodes of different graphs.

### SUMMARY AND OBJECTS OF THE INVENTION

Toward this and other objects that are made obvious in light of the present disclosure, a method and system are provided for accessing graphs, including social graphs, in performing searches across graphs by discovering or forming connectivity pathways between nodes representing entities, persons, physical objects, and/or discrete or aggregated information. It is understood that scope of the meaning of the term entity as defined herein includes a person, an event, a concept, a corporation, a physical object, a fictional character, a polity, an ethnicity, an information and/or an association, grouping or collection of entities.

In a first aspect of the invented method, a server receives a query message from a requester that identifies a source node of a first graph and includes a target information. The requester may be an owner of the source node. The server then preferably searches a plurality of graphs to locate one or more nodes that include or are associated with the target information. When one or more nodes, or target nodes, are found by the server, the server informs the requester and requests authorization to attempt to form a pathway between the source node and one or more target nodes. The server may offer additional information harvested from a target node to the requester in order to encourage the requesting party to authorize pathway formation to the instant target node.

According to a second optional aspect of the invented method, an owner or controller of an intervening node of a potential pathway between the source node and a target node may be offered a reward to extend the potential pathway to link two graphs.

According to a third optional aspect of the invented method, the pathway may include a node of a social network and/or a web or network accessible database.

According to a fourth optional aspect of the invented method, the server directs an electronic message may comprise an invitation to link through a graph, a network address of the source node, and/or an identifier of the requesting party.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE FIGURES

Features and advantages of the present invention will become more apparent from the following detailed description of exemplary embodiments thereof taken in conjunction with the accompanying drawings in which:

FIG. 1 is block diagram of an information technology network and an isolated data base server, wherein a query server has access to both each graph of both and the isolated data base server and a plurality of graph servers that each maintain digitized information that separately define unconnected graphs;

FIG. 2 is a representation of a pathway that traverses two unconnected graphs that are each generated by separate servers of FIG. 1;

FIG. 3 is a representation of the pathway of FIG. 2 wherein a cross link generated by the invented method allows two nodes of separate unconnected graphs of FIG. 2 to communicate;

FIG. 4 is a flowchart of the query server of FIG. 1 that includes aspects of the invented method that enable communication by nodes of separate nodes across unconnected graphs;

FIG. 5 is an alternate flowchart that comprises additional aspects of the invented process that enable communication across two or more unconnected graphs of FIG. 1;

FIG. 6 is an other flowchart of alternate aspects of the invented process as directed by the query server of FIG. 1 and that enable communication between two unconnected nodes across two or more unconnected graphs of FIG. 1;

FIG. 7 is an additional flow chart of adding an offer of compensation to a request addressed to a crosslink node;

FIG. 8 is an additional flow chart of the query system of FIG. 1 requesting permission from the source node of FIG. 2 to attempt to contact a crosslink node;

FIG. 9 is a yet additional flowchart of the query system of FIG. 1 reading information from or associated with the target node and providing this information to the source node prior to the query system requesting permission from the source node of to contact a crosslink node of FIG. 2;

FIGS. 10A-10D are each block diagrams of messages useful in the implementation of certain optional aspects of the invented method;

FIG. 11 is a representation of a source node and a target node that are in separate and unconnected graphs and an intervening an unconnected graph through which a pathway from the source node and the target node might be extended, wherein each of the these three are each generated by separate servers of FIG. 1;

FIG. 12 is a representation of an instantiated pathway from the source node and the target nodes of FIG. 13 and wherein the pathway fully traverses through the intervening and initially unconnected third graph; and

FIG. 13 is a software flowchart of the query system of FIG. 1 defining the pathway of FIG. 12 as containing two cross links.

### DESCRIPTION

It is to be understood that this invention is not limited to particular aspects of the present invention described, as such may, of course, vary. It is also to be understood that the terminology used herein is for the purpose of describing particular aspects only, and is not intended to be limiting, since the scope of the present invention will be limited only by the appended claims.

Methods recited herein may be carried out in any order of the recited events which is logically possible, as well as the recited order of events.

Where a range of values is provided herein, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the methods and materials are now described.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

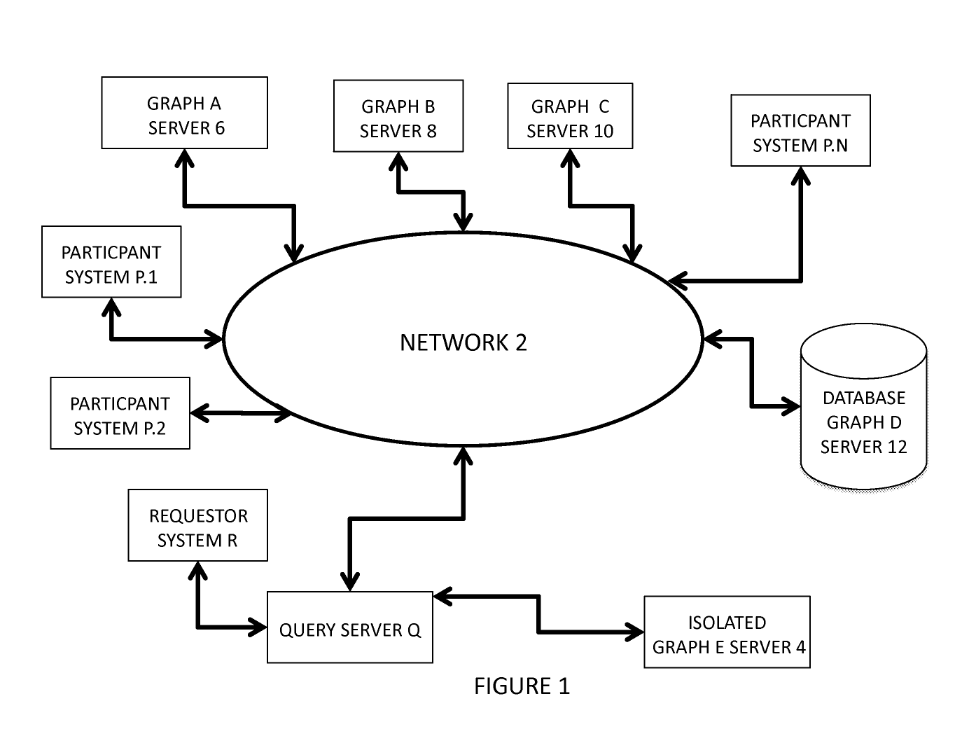

FIG. 1 is block diagram of an information technology network 2 and an isolated graph server 4, wherein the isolated graph server 4 and a plurality of graph servers 6-12 of the information technology network and the isolated server 4 each maintain digitized information that define unconnected graphs A-E. A query system Q has the capability and the required authorizations to have visibility into each of the plurality of graphs A-E that are generated in whole or in part by the servers 6-12. Towards this end, the query system 14 is bi-directionally communicatively coupled with the isolated graph server 4 and further bi-directionally communicatively coupled with the plurality of graph servers 6-12 by the information technology network 2 (hereinafter, “the network” 2). The network 2 may be in certain alternate preferred embodiments of the invented method be or comprise the Internet, one or more telephony networks, and one or more electronic communications networks. The network 2 is defined herein to include all servers and systems disclosed herein other than the isolated server 4.

The plurality of graph servers 6-10 each maintain and generate graphs A-C that are each social network services that include distinguishable and individually addressable user accounts, such as FACEBOOK™ and LINKEDIN™ and the like. A data base graph server 12 maintains and generates a graph D that is formed from a data base wherein data represented by the graph D is not essentially linked to social networking user accounts. The isolated server 4 maintains and generates an isolated graph E that may be a user account based social graph or merely representative of a data base.

The network 2 further includes a requestor system R and a plurality of participant systems P.1-P.N. Each participant system P.1-P.N enables a user to participate in one or more social graphs A-C and E, and the requestor system R enables a requesting party to bi-directionally communicate with the query system Q, one or more social graphs A-and preferably one or more participant systems P.1-P.N.

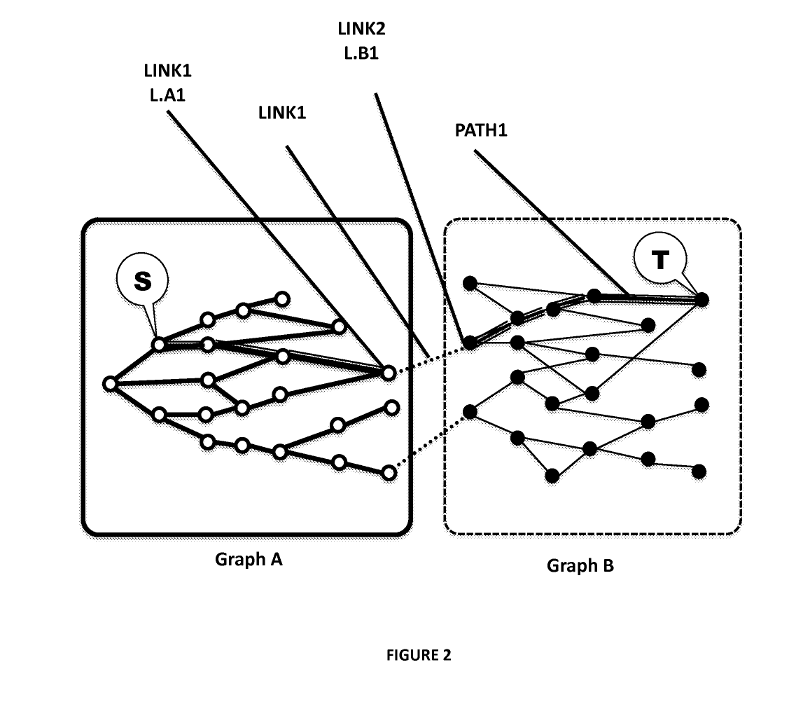

FIG. 2 is a representation of two unconnected social graphs A & B that are each generated by servers 6 & 8. Consider a first case where a requesting party having access to the requester system R the wishes to locate and communicate with a target party. Supposing that the requesting party has no knowledge as to whether the target party participates in or is referenced by any social graph A-C & E or database graph D, and the requesting party directs the query system Q to search all graphs available to the query system Q to determine if the target party might be an account holder with any available social graph.

In the instant case the requesting party is the account holder of a source account of the first social graph A that is expressed as a source node S, wherein the first social graph A is a social network web service, and possibly unbeknownst to the requesting party, the target party is the account holder of a target account of the second social graph B that is expressed as a target node T, and the second social graph B is a second social networking web service. In this exemplary scenario, the target party has access to the network 2 via a first participant system P.1. By way of illustration, consider that the first social networking web service is FACEBOOK™, and the second social networking service is LINKEDIN™.

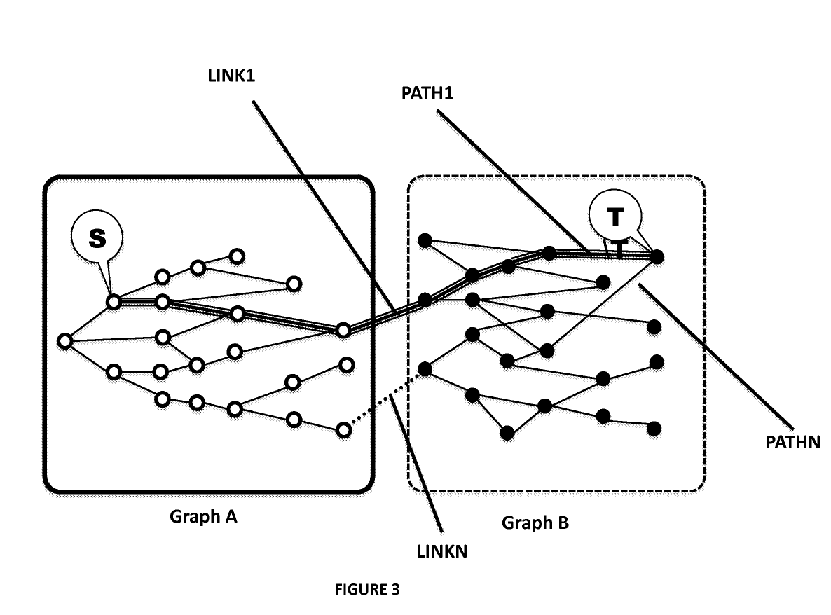

The query server Q analyzes the plurality of graphs A-E to generate the first pathway PATH1 of FIG. 2 and determines, discovers or is informed by a graph server 4-12 that a first cross link LINK1 exists between the first social graph A and the second social graph B. Aspects of the invented method are applies as described in the present disclosure to secure permission from a third party with access to the first cross link LINK1 and/or a server 4-12 that has authority over the first cross link LINK1 to instantiate the first crosslink LINK1 and thereby fully form the first pathway, if only for a communication of a single electronic message from the source node S and to the target node T. FIG. 3 represents the integration of the cross link LINK1 as a functioning edge of the first pathway PATH1.

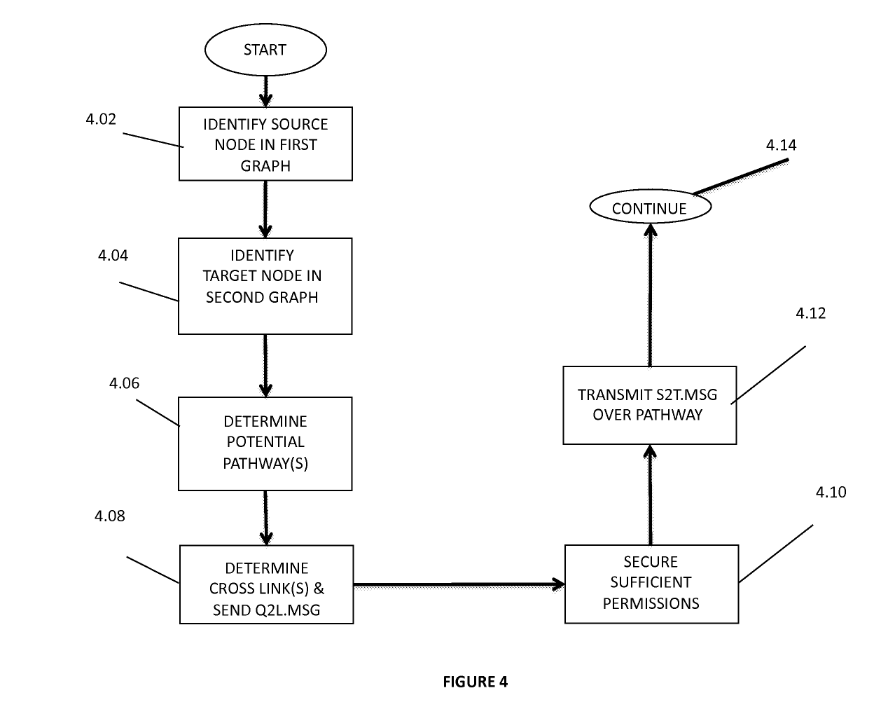

Referring now generally to the Figures and particularly to FIG. 4, FIG. 4 is a software chart of the query server Q that includes a first preferred embodiment of the invented method. The Q receives a request message to connect with the target party in step 4.02, wherein the request message identifies the source node S of the requesting party and includes at least one target information associated with the target party. The query server Q next exercises, explores and queries the graphs A-E and the graph servers 6-12 and determines, discovers, or may be informed by one or more servers 6-12 of the target node T. Target node T may be selected for commonality with the target information provided in the request message. For example, the request message target information may include a first name, a last name and a date of birth of the target party, and the target node T may be associated with these same name and date of birth data. The query server Q the maps out possible pathways PATH1-PATHN between the source node S and the target node T in step 4.06, and determines or discovers intermediary nodes that form cross links LINK1-LINKN between unconnected graphs A-E in step 4.08. Alternatively, one or more servers 6-12 may inform the query server Q of one or more intermediary nodes that form the cross links LINK1-LINKN in step 4.08. Still optionally, in the process of exploring possible pathways, a third party may be invited to suggest, or simply suggest without invitation, additional nodes to which the instant third party is in communication with as possible nodal constituents of a pathway PATH1-PATHN to the target node.

The query server Q next attempts to secure all necessary permissions to authorize communication across the cross links LINK1-LINKN in step 4.10 and if successful in securing permissions, applies the instant cross links LINK1-LINKN in step 4.12 to transmit a contact message from a node of a first graph A-E to another node of a second graph A-E that is not connected by edges with the first graph A. The query server Q proceeds on from step 4.12 to step 4.14 to perform alternate computational operations.

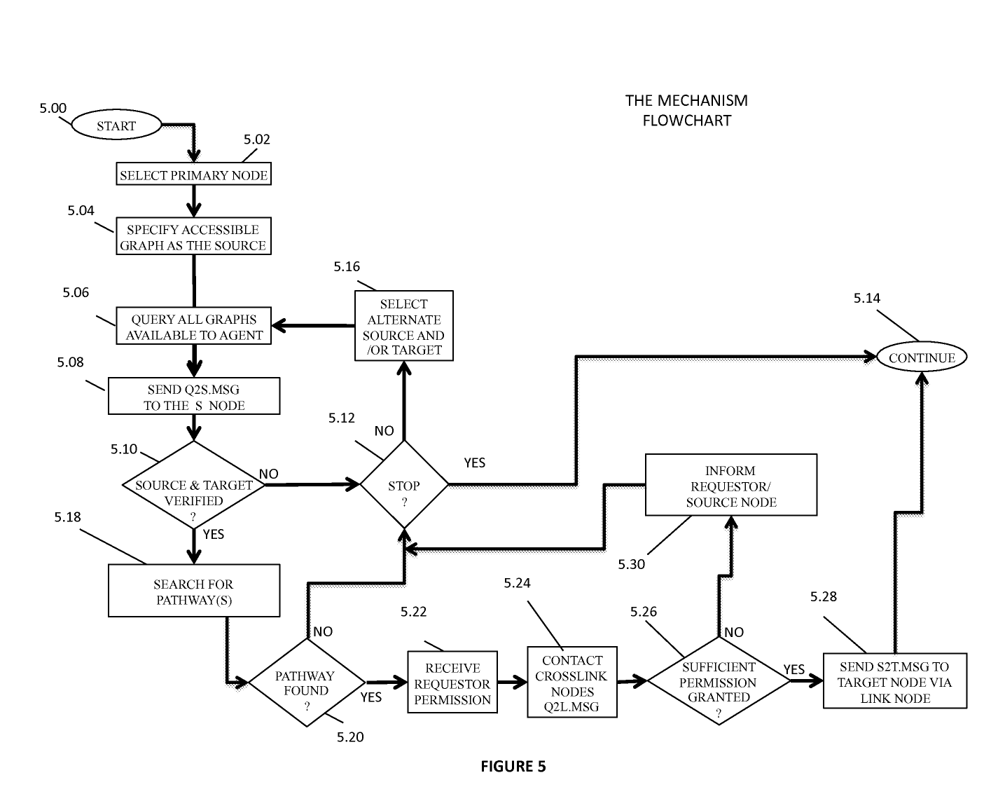

Referring now to FIG. 5, FIG. 5 is an alternate flowchart of additional aspects of the invented process that enable communication across two or more unconnected graphs of FIG. 1. The query server Q selects a primary node of the first graph A as a source node, typically in response to having received a requesting message S2Q.MSG from the requesting party and preferably explicitly citing a network address of the source node S, i.e., a “source address” S.ADDR. The source address S.ADDR may be an email address, a universal resource locator, an account name of a social network service provider, i.e., a member account with FACEBOOK™, LINKEDIN™ or other suitable social network services provider known in the art, or other suitable address to which electronic messages can be successfully delivered. The query server Q selects and assigns the graph A-E of the source address S.ADDR as the source graph in step 5.04.

The query server Q then initiates querying all graphs A-E available to the query server Q in step 5.06 sends at least one or more candidate target nodes of graphs B-E external to the source graph A of the source node S to the requesting party, (abbreviated to “REQUESTOR” in the flow charts), preferably in a candidate target data message Q2S.MSG and bearing candidate target data TNODE.DATA,to the source node address S.ADDR in step 5.08. When the requesting party fails to verify a candidate node to the query server Q in step 5.10 and/or the source node S or requesting party sends an explicit instruction to the query server Q to not proceed on to searching for pathways to any of the candidate nodes, the query server Q proceeds on to step 5.12. The query server Q determines in step whether to proceed to step 5.14 and to stop searching for candidate target nodes, or to proceed on to step 5.16 and to search for other target nodes.

The query server Q searches for a shortest pathway to one or more target nodes T in step 5.18 after verification by the requesting party or by instruction from the source node S in step 5.10. The query server Q determines in step 5.20 whether a pathway from the source node S of graph A to the target node T of an unconnected graph B-E can be established by cross linking from at least graph A, and possible by traversing through one or more other unconnected graphs B-E. When no pathway is found by the query server Q in step 5.20 to the target node selected or authorized in the last execution of step 5.12, the query server Q proceeds from step 5.20 to step 5.12. The query server Q determines in step whether to proceed to step 5.14 and to stop searching for candidate target nodes, or to proceed on to step 5.16 and to search for other target nodes.

When the query server Q defines a pathway PATH1-PATHN in step 5.18 and determines in step 5.20 that a valid pathway with one or more cross links LINK1-LINKN has been defined, generated or found, the query server optionally requests and must receive permission or authorization from the requesting party, preferably in a communication to the query server Q from the source node S in step 5.22. When permission from the requesting party is either (a.) not required or (b.) is actually by the query server Q, the query server Q proceed on to step 5.24, WHEREIN THE QUERY SERVER Q issues one or more crosslink node message Q2L.MSG to one or more intermediary nodes L.1 & L.B1, or “cross link nodes” L.1 &L.B1, to request authorization, permission, or activation of one or more cross links LINK1-LINKN of one or more pathways PATH1-PATHN to the target node T as found, defined or generated in step 5.18. Optionally, only a shortest pathway PATH1 may be selected in step 5.20. It is understood that the cross link message Q2L.MSG may contain a promise of compensation PROMISE.TXT that offers consideration, e.g., a monetary payment or other value or credit, to accept and perform as requested in forming the desired cross link CLINK1-CLINKN between the source graph A and an other, unconnected graph B-E.

When sufficient acceptances of connection requests of one or more cross link messages Q2L.MSG are received in step 5.26 by the query server Q to complete a pathway PATH1-PATHN to the target node T, the query server proceeds from step 5.26 to step 5.28 and sends a source-to-target message S2T.MSG as previously authorized and instructed by the requesting party to the target node T and through the instant pathway PATH1-PATHN. The query server Q proceeds from step 5.28 to step 5.30 and to perform alternate or additional computational or communication processing. When sufficient acceptances of cross link messages Q2L.MSG are not received in step 5.26, the query server Q proceeds on to step 5.32 and to inform the receiving party, preferably be an electronic message to the source node S, of this insufficiency of acceptances of connection requests as issued in step 5.24.

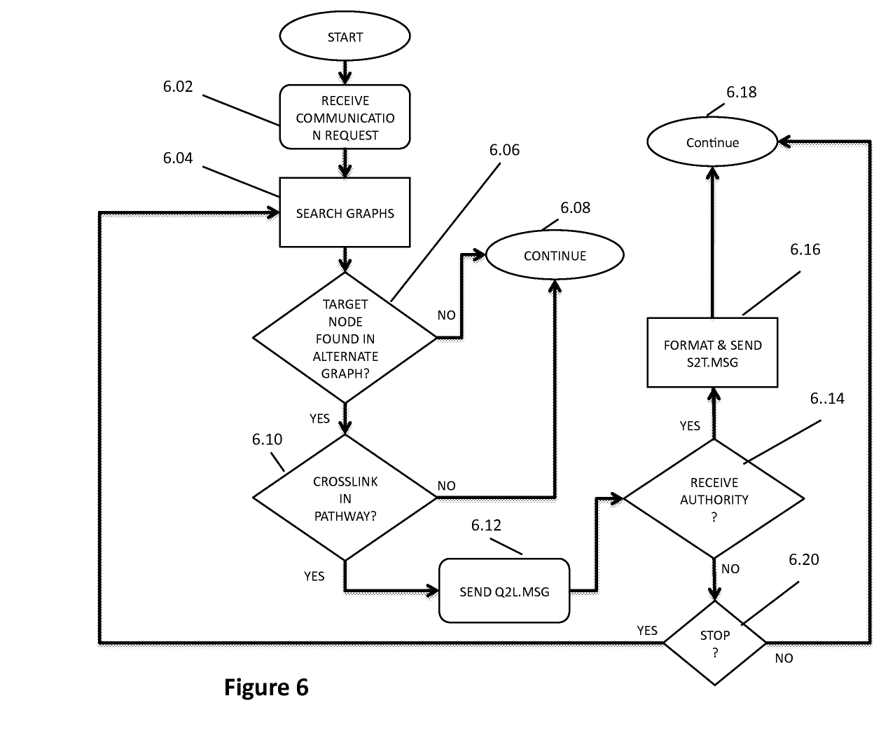

Referring now to FIG. 6, FIG. 6 is a third software flowchart of an alternate preferred embodiment of the invented method as performed by the query server Q, wherein the query server Q receives a requesting message S2Q.MSG from the requesting party, and preferable from the source node S, wherein the requesting message S2Q.MSG provides certain target information INFO.TARGET that may aid the query server Q in finding a target node that is related to the target information INFO.TARGET and identifies the first graph A as comprising the source node S. The query server Q then searches all graphs A-E accessible to the query server Q for nodes that may be associated with or identified by the target information INFO.TARGET, and for pathways PATH1-PATHN to such target nodes T, in step 6.04. When no candidate target node of any unconnected graph B-E is determined to in step 6.06, the query server Q proceeds on from step 6.06 to step 6.08 and to apply other search processing techniques and/or proceed on to other activities.

Alternatively, when at least one candidate target node of an unconnected graph B-E is determined to have been found in step 6.06, the query server Q proceeds on from step 6.06 to step 6.10. If no pathway PATH1-PATHN comprising a cross link CLINK1-CLINKN is determined in step 6.10 to have been generated or discovered in step 6.04, the query server Q proceeds on from step 6.010 to step 6.08 and to apply other search processing techniques and/or proceed on to other activities.

When a pathway PATH1-PATHN to a target node T comprising at least one cross link CLINK1-CLINKN is determined in step 6.10 to have been generated or discovered, the query server Q proceeds form step 6.10 to step 6.12 and to request permission and/or cooperation in step 6.12 of relevant third parties to instantiate the one or more cross links CLINK1-CLINKN determined in step 6.10 to be of a selected pathway PATH1-PATHN to the target node T. When the query server Q determines in step 6.14 that sufficient permission has been received from relevant third parties, to include authorized automated or software agents of third parties such as persons, organizations or equipment. When sufficient permission is determined by the query server Q to have been received in step 6.14, the query server Q proceeds on to step 6.16 and to send the source-to-target message S2T.MSG. The query server Q proceeds on from step 6.16 to step 6.18 and to perform alternate computational operations.

When sufficient permission is determined by the query server Q to not have been received in step 6.14, the query server Q proceeds on to step 6.20 and determines whether to proceed on to step 6.04 and search the accessible graphs A-G again, or to step 6.18.

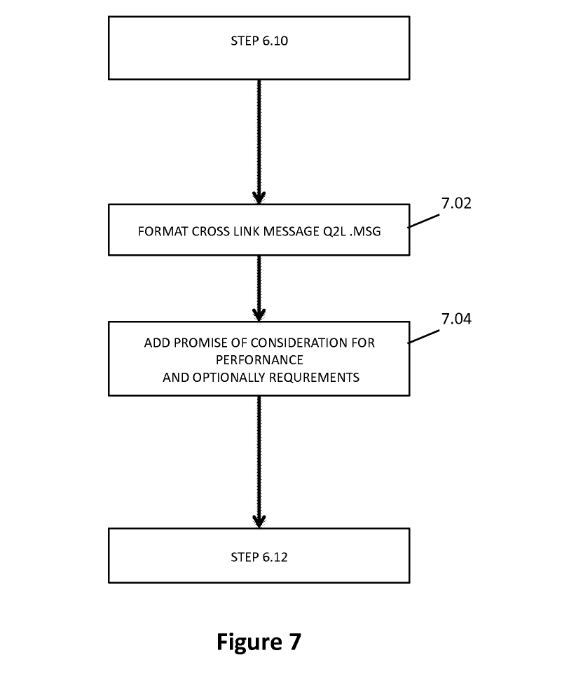

Referring now to FIG. 7, the query system Q query system formats a Q2L.MSG in step 7.02 addressed to a link node L.ADDR of a link node L.A1-L.B1 and in optional step 7.04 adds a promise PROMISE.TXT of compensation for agreeing to allow or effect a desired link LINK1-LINKN and/or a asserts a required performance or condition for the consideration to be earned in a requirement statement REQUIRE.TXT.

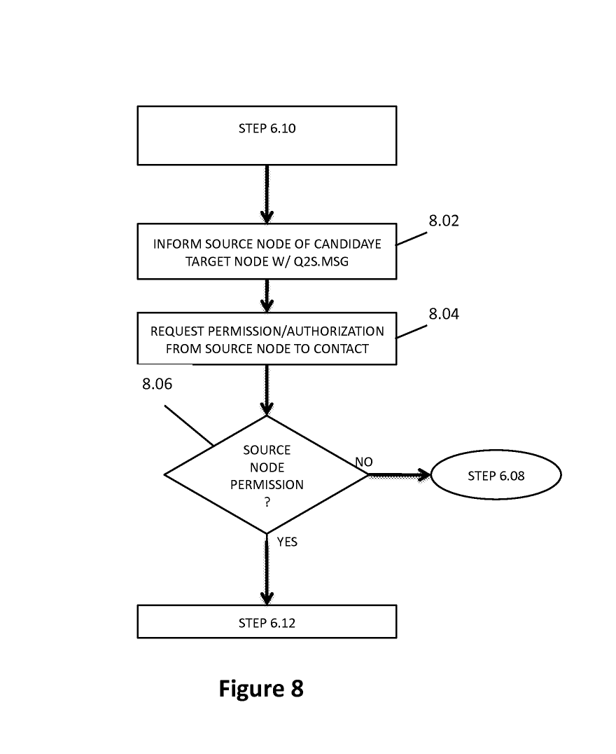

Referring now to FIG. 8, the query system Q informs the source node S of a target node in step 8.02 and requests permission or authorization from the source node S to contact the target node T. When a required permission or authority to contact the target node T is not received by the query system Q, or an instruction sent from the source node S to not contact the target node T is received by the query system in step 8.04, the query system Q proceeds from step 8.06 to step 6.08. When the permission or authorization is received by the server in step 8.06, the query system Q proceeds from step 8.06 to step 6.12.

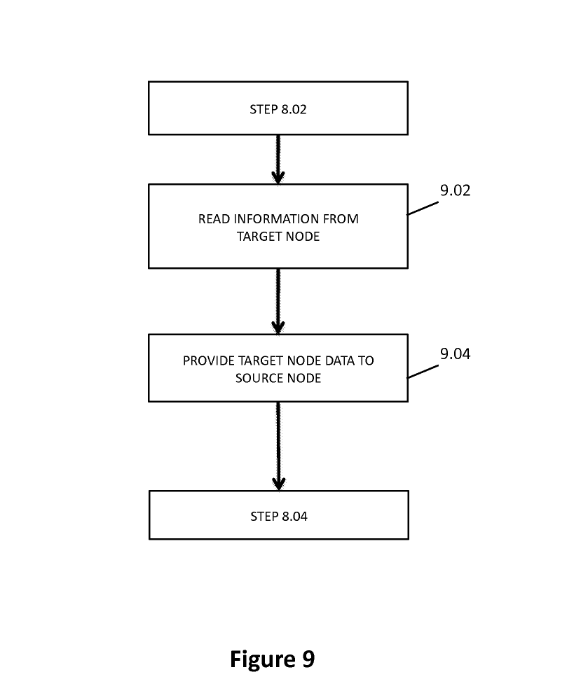

Referring now to FIG. 9, the query system Q reads information from the target node T, or a target account associated with the target node T in step 9.02, and provides the source node S with the target node information in step 9.04. For example, consider that the target node T represents a person and a target account associated with this person presents that the associated person is a military veteran. If this information had been read by the query server Q in step 9.02, this target associated information would be provided to the source node in step 9.04. This target associated information might then be considered by the receiving party in determining whether or not to instruct or permit the query server Q to contact the cross link node L.A1, L.B1, L.B2 & L.C2.

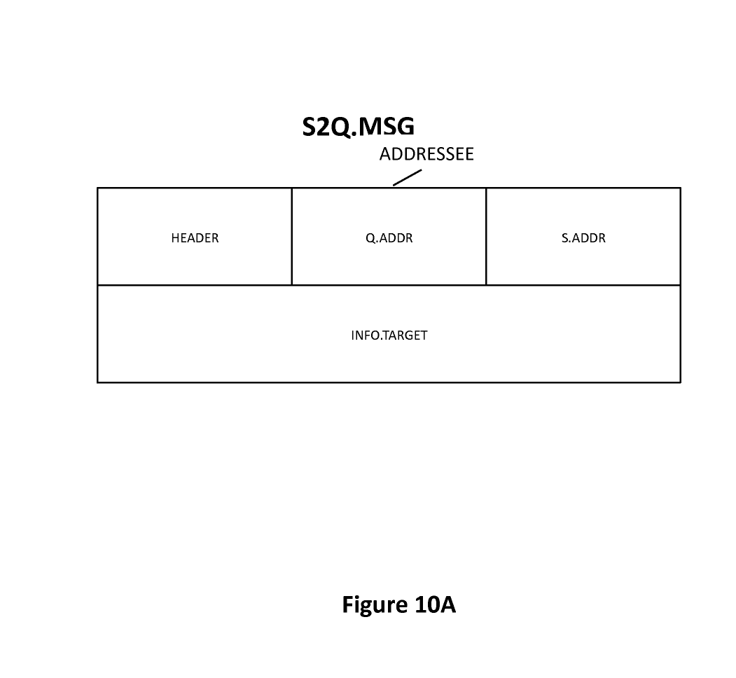

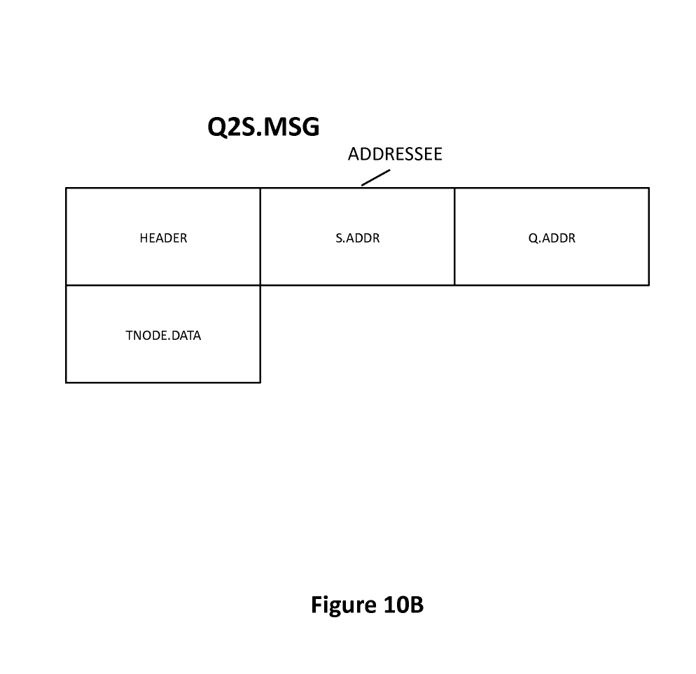

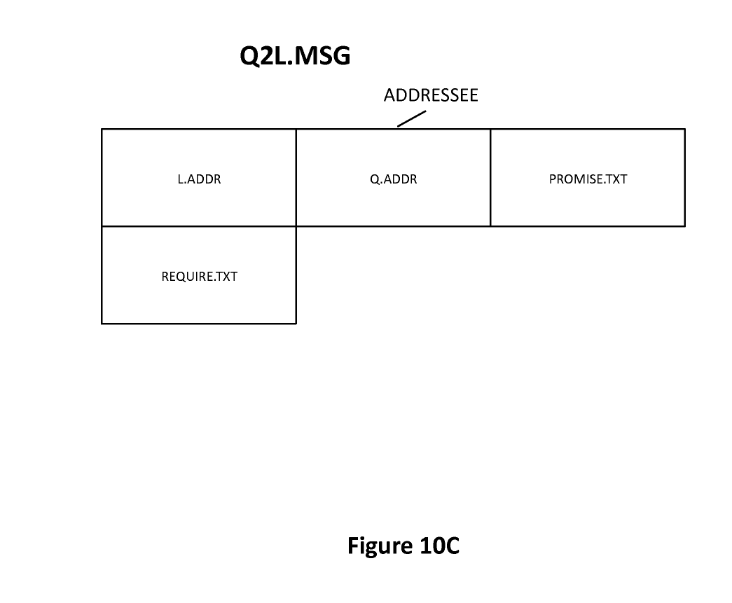

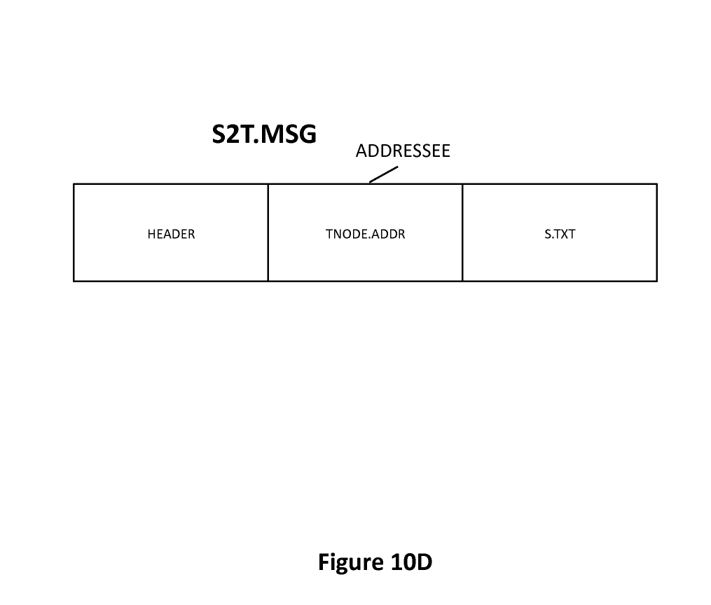

Referring now to FIG. 10A, FIG. 10A is a block diagram of a requestor message S2Q.MSG the requesting party might send from the source node S to the query server Q, and that the query server Q might receive in steps 4.02 5.00, and/or 6.02. The requestor message preferably includes the query system network address Q.ADDR as the requestor message addressee, the source node network address S.ADDR as the requestor message sender identifier, and some target information INFO.TARGET that preferably is supportive of identifying the target party. The target information INFO.TARGET most preferably suggest a graph where the target node T might be located, most preferably identifies the target node T and graph B-E comprising the target node.

Referring now to FIG. 10B, FIG. 10B is a block diagram of the candidate target data message Q2S.MSG of steps 5.08 and 8.04. The candidate target data message Q2S.MSG preferably includes the source node network address as the message addressee, the query system network address Q.ADDR as message sender, and target information TNODE.DATA that is associated with the target node and/or is harvested from the target node T or an associated target account associated with the target node T.

Referring now to FIG. 100, FIG. 100 is a block diagram of a cross link message Q2L.MSG of steps 4.10, 5.24 and/or 61.2. The cross link message Q2L.MSG preferably includes the link node network address L.ADDR as the message addressee, the query system network address Q.ADDR as message sender, the compensation statement and promise PROMISE.TXT and the optional performance or condition stipulations REQUIRE.TXT.

Referring now to FIG. 10D, FIG. 10D is a block diagram of a source-to-target-message S2T.MSG of steps 4.12, 5.28 and/or 6.16. The source-to-target-message S2T.MSG preferably includes the target node network address T.ADDR as the source-to-target message addressee, the source node network address S.ADDR as the source-to-target message sender identifier, and a source message S.TXT that (a.) the requesting party wishes to send to the target party; and/or (b.) the source node S intend to provide to the target node T.

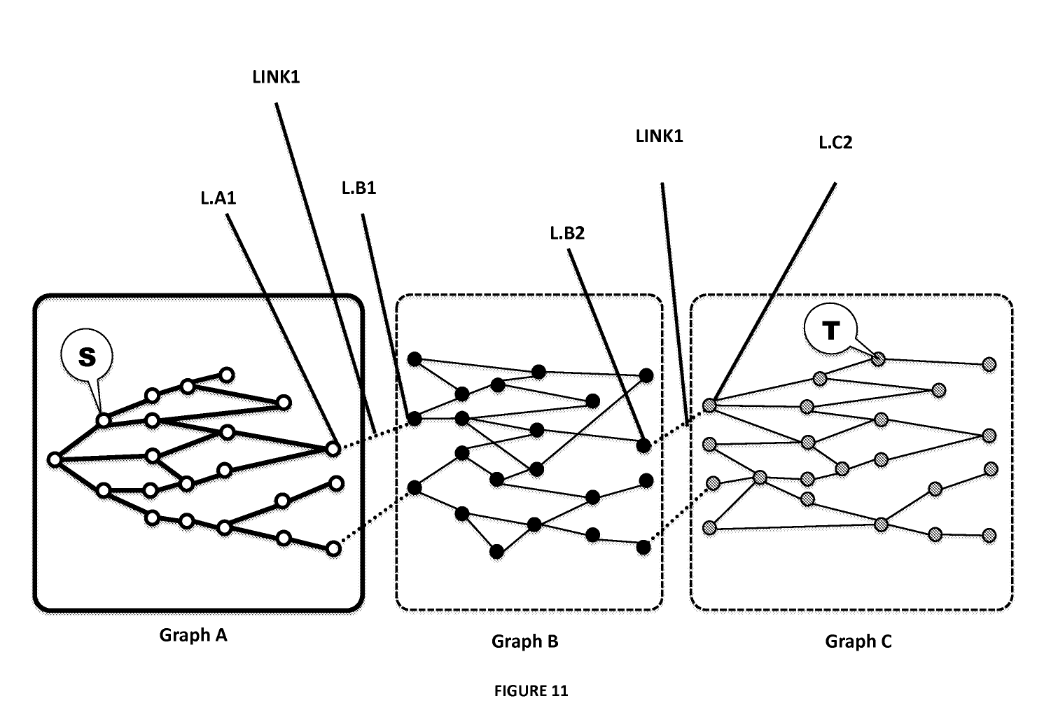

Referring now to FIG. 11, FIG. 11 presents the occasion where a shortest pathway PATH2 from the source node S of graph A to the target T2 node of a third graph C traverses through the second graph B. In this exemplary case, the query server Q is tasked with securing support and/or permission from at least two cross link nodes L.A1 & L.B2 to form two cross links LINK1 & LINK2.

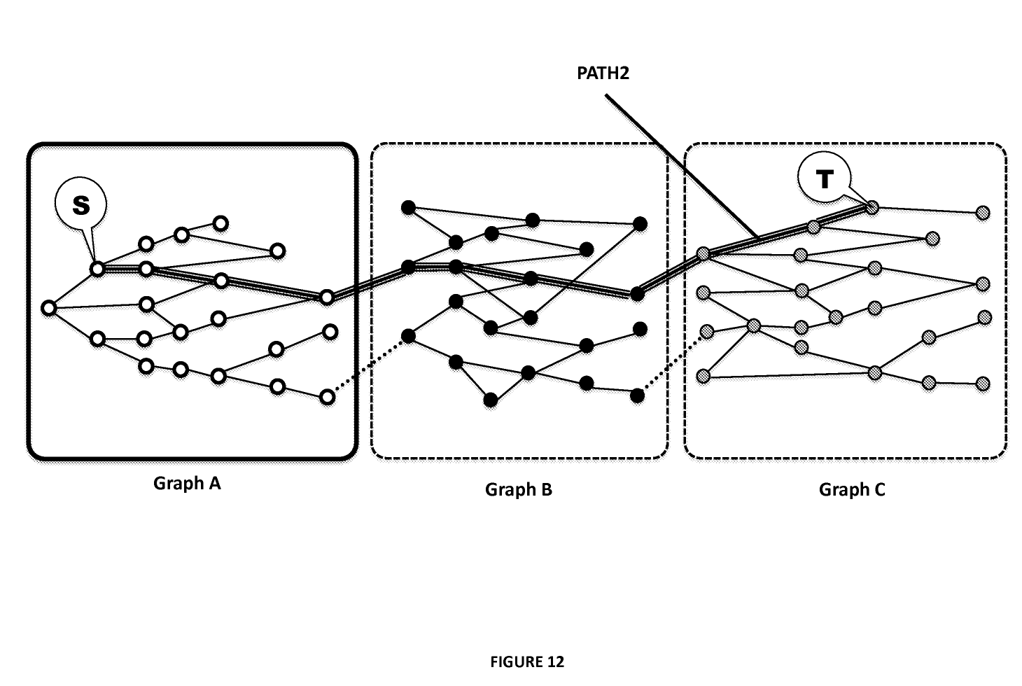

Referring now to FIG. 12 is a representation of an instantiated second pathway PATH2 from the source node S and to the second target node T2, wherein the second pathway PATH2 fully traverses from the first graph A and two the third graph C by means of traversing fully through the intervening and initially unconnected second graph B.

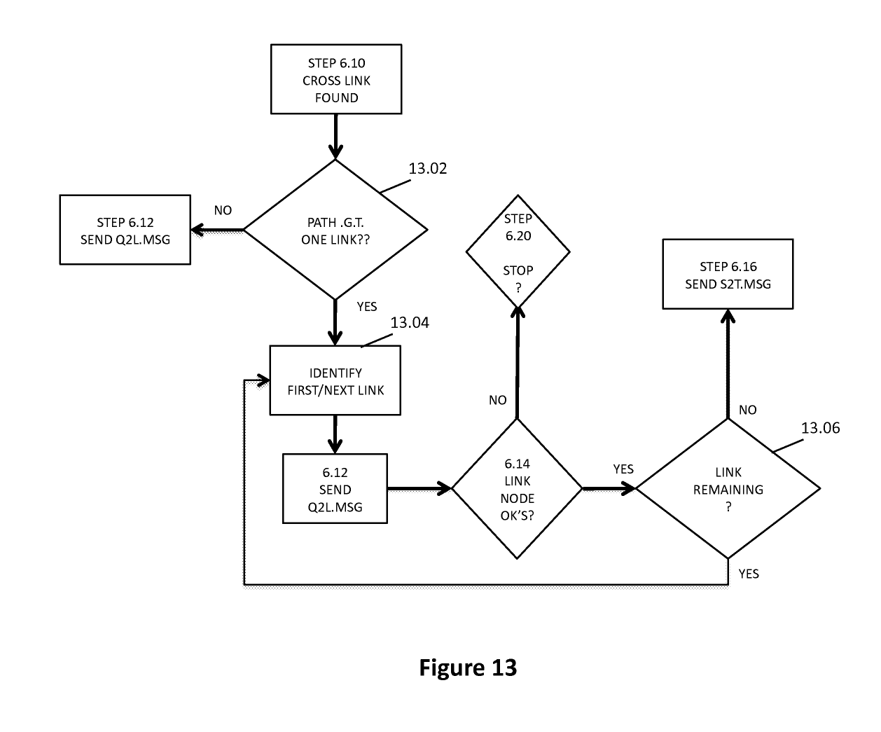

Referring now to FIG. 13, Figure is a software flowchart of additional actions performed by the query system Q in securing sufficient permissions and/or support from the cross link nodes L.A1, L.B1, L.B2 & L.C2. From step 6.10 of the process of FIG. 6, the query server Q proceeds to step 13.02 and to determine if a design of a potential pathway PATH2 requires the instantiation or performance of more than one cross link LINK1-LINKN. When the query server Q determines that the design of a potential pathway PATH2 does not require the instantiation or performance of more than one cross link LINK1-LINKN, the query server Q proceeds from step 13.02 to step 6.12.

In the alternative, when the query server Q determines that the design of a potential pathway PATH2 does require the instantiation or performance of more than one cross link LINK1-LINKN, the query server Q proceeds from step 13.02 to step 13.04 and cycles through the loop of steps 6.16, 6.18, 13.06 and 13.04 until all either (a.) necessary cross link permission or support is denied or the cross link requests Q2L.MSG go unanswered; or (b.) sufficient cross link permission or authority or received by the query system Q. When sufficient cross link permission or authority or received by the query system Q, the query system Q proceeds from step 13.06 and too step 6.16 and sends the source-to-target message S2T.MSG into the second pathway PATH2.

One skilled in the art will recognize that the foregoing examples are not to be taken in a limiting sense and are simply illustrative of at least some of the aspects of the present invention.

I claim:

1. A computer-implemented method comprising:
Receiving a query from a requesting party comprising an identification of a source node of a source graph and a target information related to a target entity;
Searching a plurality of graphs for a candidate target node of a second graph, wherein the candidate target node has at least one information suggesting a relatedness to the target information;
Finding a candidate target node in a second graph:
Determining a pathway from the source graph to the candidate target node, the pathway having at least one cross link that requires a permission from a third party to transfer communication from the source graph to the second graph;
Receiving an authorization from the third party to transmit a message from the source graph to the second graph via the at least one cross link; and
Communicating a contact message from the source graph to the second graph via the at least one cross link and to the candidate target node.

2. The computer-implemented method of claim 1, wherein the contact message is addressed to the candidate target node.

3. The computer-implemented method of claim 1, wherein the contact message is indicated to have been transmitted by the requesting party.

4. The computer-implemented method of claim 1, wherein a permission is required from the requesting party to authorize seeking the third party authorization to communicate via the at least one cross link.

5. The computer-implemented method of claim 4, further comprising requesting the permission of the requesting party to seek the third party authorization to access the at least one cross link.

6. The computer-implemented method of claim 2, further comprising:
Reading the candidate target node for information related to the target entity; and
Providing at least one information read from the candidate target node to the requesting party prior to requesting permission of the requesting party to seek the third party authorization to transfer communication across the at least one cross link.

7. The computer-implemented method of claim 1, further comprising offering consideration to the third party in compensation for authorizing communication of a message from the source graph to the second graph via the at least one cross link.

8. The computer-implemented method of claim 7, wherein the offer of consideration stipulates that the authorized communication be addressed to the candidate target node.

9. The computer-implemented method of claim 1, wherein the requesting party is an owner of a source account, wherein the source node is an expression of the source account.

10. The computer-implemented method of claim 9, wherein the identification of the source node is an account name of the source account.

11. The computer-implemented method of claim 1, wherein the identification of the source node is a first graph identifier of the source node.

12. The computer-implemented method of claim 1, wherein a plurality of pathways are determined between the source node and the candidate target node and a shortest pathway is accessed first to communicate an electronic message to the candidate target node.

13. The computer-implemented method of claim 12, wherein a second pathway of plurality of pathways is accessed to communicate the electronic message to the candidate target node after a failure to transmit the electronic message to the candidate target node through the first pathway is determined.

14. The computer-implemented method of claim 1, wherein the contact message is an electronic message.

15. The computer-implemented method of claim 14, wherein the electronic contact message comprises a network address of the source node.

16. The computer-implemented method of claim 14, wherein the electronic contact message comprises an identifier of the requesting party.

17. The method of claim 1, wherein the requester provides consideration in compensation for transmission of the contact message via the pathway to the candidate target node to a service provider.

18. The method of claim 1, wherein the pathway extends through a third graph, the third graph disposed between the first graph and the second graph, and a second authorization is required from a fourth party to enable communication from the third graph to the second graph.

19. In an electronic communications network, a method comprising:
a. Determining a pathway communicatively coupling a source node and a target node, the pathway comprising a plurality of intermediary nodes and extending through at least two graphs; and
b. Offering an owner of at least intermediary node a consideration in compensation for enabling transmission of an electronic message through the pathway.

20. A system comprising:
a. Means to determine a pathway communicatively coupling a source node and a target node, the pathway comprising a plurality of intermediary nodes and extending through at least two graphs; and
b. Means to offer at least one owner of at least one intermediary node a consideration in compensation for enabling transmission of an electronic message through the pathway.
